(19) United States
(12) Patent Application Publication
(10) Pub. No.: US 2026/0335984 A1
(43) Pub. Date: Oct. 29, 2026

(54) CUTTING TIP HOLDER AND CUTTING TOOL

(71) Applicant: KAWASAKI JUKOGYO KABUSHIKI KAISHA, Kobe-shi, Hyogo (JP)

(72) Inventor: Tatsuya SATO, Kobe-shi, Hyogo (JP)

(73) Assignee: KAWASAKI JUKOGYO KABUSHIKI KAISHA, Kobe-shi, Hyogo (JP)

(21) Appl. No.: 19/117,826

(22) PCT Filed: Sep. 20, 2023
(86) PCT No.: PCT/JP2023/034127

§ 371 Date: Apr. 2, 2025

(30) Foreign Application Priority Data
Oct. 4, 2022 (JP) 2022-160250

(51) Int. Cl. B23B 27/10; B23B 29/12

(52) U.S. Cl. CPC B23B 27/10; B23B 29/12; B23B 2250/12

(57) ABSTRACT

A cutting tip holder includes a head block and first and second coolant nozzles. The head block includes: first to third block surfaces; and an attachment structure with a cutting tip attached such that the first block surface is viewable in a normal direction of a first tip surface, the second block surface viewable in a normal direction of a second tip surface, and the third block surface is viewable in a normal direction of a third tip surface. The first coolant nozzle is located on the first block surface. The second coolant nozzle is located on at least one of the second or third block surface. A discharge port of the first coolant nozzle is located so as to be directed to the first tip surface, and a discharge port of the second coolant nozzle is located so as to be directed to the second or third tip surface.

### TECHNICAL FIELD

The present disclosure relates to a cutting tip holder and a cutting tool.

### BACKGROUND ART

Known is a cutting tool which includes a cutting tip and a cutting tip holder that holds the cutting tip, and cuts a workpiece by the cutting tip. The cutting tip is held by the cutting tip holder such that a rake surface thereof and flank surfaces thereof are exposed.

### CITATION LIST

### Patent Literature

PTL 1: Japanese Laid-Open Patent Application Publication No. 2001-47304

### SUMMARY OF INVENTION

### Technical Problem

According to the cutting tool, since the cutting tip increases in temperature in accordance with the cutting of the workpiece, the life of the cutting tip may be influenced. Therefore, as disclosed in, for example, PTL 1, a countermeasure to cool the cutting tip by coolant is taken. However, there is a problem that since the coolant hardly reaches the cutting tip due to the workpiece, chips, and the like, the cutting tip is hardly cooled.

An object of one aspect of the present disclosure is to provide a cutting tip holder and a cutting tool by each of which a cutting tip can be efficiently cooled by coolant.

### Solution to Problem

A cutting tip holder according to one aspect of the present disclosure is a cutting tip holder that holds a cutting tip, the cutting tip including a first tip surface, a second tip surface, and a third tip surface, each of the first tip surface, the second tip surface, and the third tip surface being located adjacent to the other two tip surfaces, the cutting tip holder including: a head block to which the cutting tip is attached; a first coolant nozzle including at least one discharge port; and at least one second coolant nozzle including at least one discharge port, wherein: the head block includes a first block surface, a second block surface, and a third block surface, each of the first block surface, the second block surface, and the third block surface being located adjacent to the other two block surfaces, and an attachment structure by which the cutting tip is attached in such a posture that the first block surface is visually recognized when viewed in a normal direction of the first tip surface, the second block surface is visually recognized when viewed in a normal direction of the second tip surface, and the third block surface is visually recognized when viewed in a normal direction of the third tip surface; the first coolant nozzle is located on the first block surface of the head block; the second coolant nozzle is located on at least one of the second block surface or third block surface of the head block; the at least one discharge port of the first coolant nozzle is located so as to be directed to the first tip surface of the cutting tip; and the at least one discharge port of the second coolant nozzle is located so as to be directed to the second tip surface or third tip surface of the cutting tip.

### Advantageous Effects of Invention

One aspect of the present disclosure is to provide a cutting tip holder and a cutting tool by each of which a cutting tip can be efficiently cooled by coolant.

### BRIEF DESCRIPTION OF DRAWINGS

FIG. 1 is an appearance diagram of a cutting tool according to an embodiment.

FIG. 2 is a partial view showing a cutting tip attached to the cutting tool of FIG. 1 and components around the cutting tip.

FIG. 3 is a partial sectional view showing the cutting tip attached to the cutting tool of FIG. 1 and the components around the cutting tip.

FIG. 4 is a partial view viewed from a side where a first tip surface of the cutting tool of FIG. 1 which is performing cutting work is located.

FIG. 5 is a partial view viewed from a side where a second tip surface of the cutting tool of FIG. 1 which is performing the cutting work is located.

FIG. 6 is a partial view showing the cutting tip attached to the cutting tool according to Modified Example 1 and the components around the cutting tip.

FIG. 7 is a partial view showing the cutting tool according to Modified Example 2.

### DESCRIPTION OF EMBODIMENTS

### Embodiment

Hereinafter, an embodiment will be described with reference to the drawings. In the following description, a normal direction of a first tip surface, a normal direction of a second tip surface, and a normal direction of a third tip surface are directions when a cutting tip 2 is attached to a cutting tip holder 3.

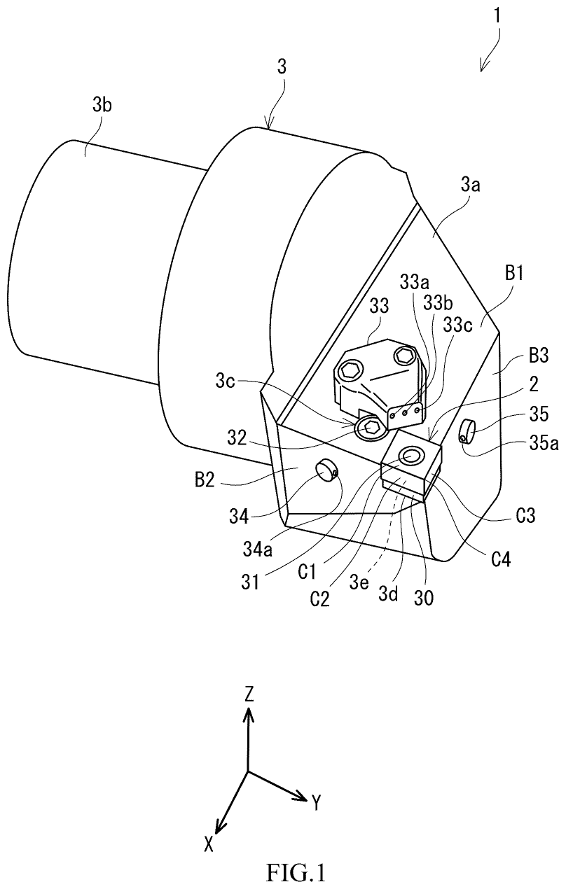

FIG. 1 is an appearance diagram of a cutting tool 1 according to the embodiment. As shown in FIG. 1, the cutting tool 1 includes the cutting tip 2 and the cutting tip holder 3 that holds the cutting tip 2. The cutting tool 1 detachably holds the cutting tip 2. The cutting tool 1 is attached to, for example, a cutter which subjects a workpiece W to lathe machining by bringing the cutting tool 1 into contact with the workpiece W while rotating the workpiece W. Heat of the cutting tip 2 which is generated during cutting work is cooled by coolant supplied to the cutting tip 2. As will be described later in detail, according to the cutting tool 1, a cooling effect of the cutting tip 2 is improved by supplying the coolant to tip surfaces C1 to C3 of the cutting tip 2.

The cutting tip 2 includes a hard material, such as hard metal. The cutting tip 2 includes the first tip surface C1, the second tip surface C2, and the third tip surface C3. Each of the first tip surface C1, the second tip surface C2, and the third tip surface C3 is located adjacent to the other two tip surfaces. The first tip surface C1 is also called a rake surface. Each of the second tip surface C2 and the third tip surface C3 is also called a flank surface. The cutting tip 2 of the present embodiment has such a cuboid shape that each of the first tip surface C1, the second tip surface C2, and the third tip surface C3 has a quadrangular shape when viewed in the corresponding normal direction.

Moreover, the cutting tip 2 includes a machining point C4 located at a boundary among the first tip surface C1, the second tip surface C2, and the third tip surface C3. The machining point C4 is also called a corner or a cutting edge. The machining point C4 contacts the workpiece W. Moreover, the cutting tip 2 includes a through hole 2a extending in a normal direction Z of the first tip surface C1. A fixture 31 of the cutting tip holder 3 described below is inserted into the through hole 2a.

The machining point C4 does not have to be a strict point. Moreover, when viewed in the normal direction Z of the first tip surface C1, a minute region of the cutting tip 2 which includes the machining point C4 may include a curve (nose R).

The shape of the cutting tip 2 is not limited to the cuboid shape and may be, for example, a columnar body shape. According to the cutting tip 2 having the columnar body shape, in a state where the machining point C4 is in contact with the workpiece W, when viewed in the normal direction Z of the first tip surface C1, a region of a peripheral surface region of the columnar body shape which is located at one side of the machining point C4 serves as the second tip surface C2, and a region of the peripheral surface region of the columnar body shape which is located at the other side of the machining point C4 serves as the third tip surface C3. To be specific, the peripheral surface of the cutting tip 2 having the columnar body shape includes the second tip surface C2 and the third tip surface C3.

The cutting tip holder 3 includes a head block 3a and an attachment block 3b. The cutting tip 2 is attached to the head block 3a. The head block 3a includes a first block surface B1, a second block surface B2, and a third block surface B3. Each of the first block surface B1, the second block surface B2, and the third block surface B3 is located adjacent to the other two block surfaces. In the present embodiment, as one example, the first block surface B1 and the first tip surface C1 are parallel surfaces. Moreover, the second block surface B2 and the second tip surface C2 are parallel surfaces. Furthermore, the third block surface B3 and the third tip surface C3 are parallel surfaces. However, the configuration of the head block 3a is not limited to this. For example, at least one of the block surface B1, B2, or B3 may have a curved surface shape or a spherical surface shape or may include surfaces.

The head block 3a includes an attachment structure 3c by which the cutting tip 2 is attached. The cutting tip 2 is attached by the attachment structure 3c in such a posture that: the first block surface B1 is visually recognized when viewed in the normal direction Z of the first tip surface C1; the second block surface B2 is visually recognized when viewed in a normal direction X of the second tip surface C2; and the third block surface B3 is visually recognized when viewed in a normal direction Y of the third tip surface C3. A posture at which the block surface is visually recognized when viewed in the normal direction of the tip surface may be such a posture that: in the case of attaching the cutting tip 2, an average worker can visually recognize the block surface when viewed in the normal direction of the tip surface; and the cutting work can be performed by the cutting tip.

The head block 3a includes a tip seat surface 3d which is opposed to a surface of the cutting tip 2 through a below-described seat 30. This surface of the cutting tip 2 is a surface opposite to the first tip surface C1. When viewed in the normal direction Z of the first tip surface C1, the tip seat surface 3d is located at a tip portion of the head block 3a at which the second block surface B2 and the third block surface B3 are adjacent to each other. The tip seat surface 3d includes an insertion hole 3e into which a tip portion of the fixture 31 is inserted. In the present embodiment, the tip seat surface 3d and the first tip surface C1 are parallel surfaces. However, the tip seat surface 3d and the first tip surface C1 are not limited to these and do not have to be the parallel surfaces.

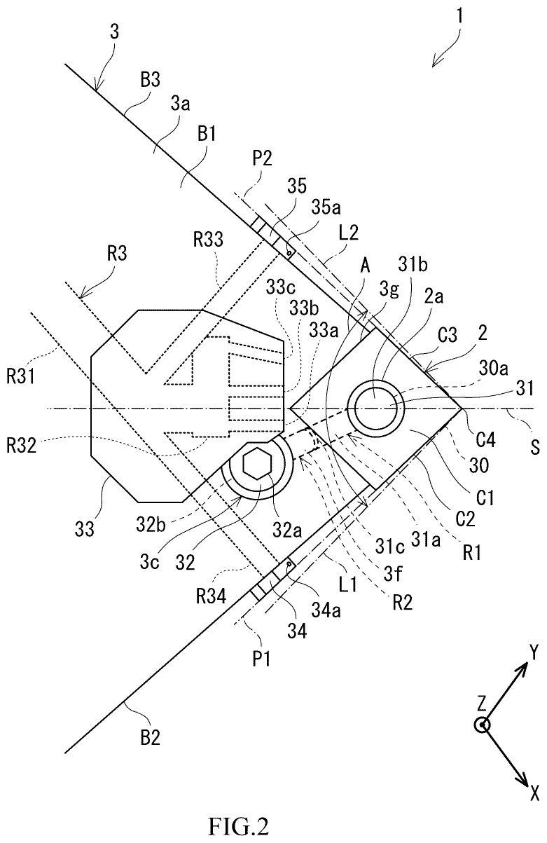

As one example, the attachment structure 3c of the present embodiment includes the seat 30, the fixture 31, and a stopper 32. The seat 30 is a plate body and is located on the tip seat surface 3d. The seat 30 includes a through hole 30a (see FIG. 2) into which the fixture 31 is inserted in a plate thickness direction. In the present embodiment, a plate surface of the seat 30 and the first tip surface C1 are parallel surfaces.

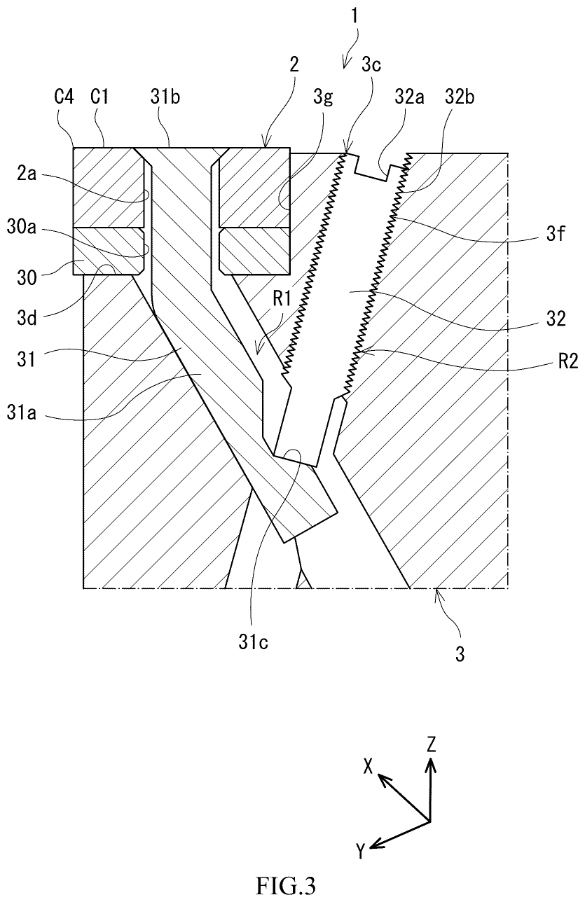

FIG. 2 is a partial view showing the cutting tip 2 attached to the cutting tool 1 of FIG. 1 and components around the cutting tip 2. FIG. 3 is a partial sectional view showing the cutting tip 2 attached to the cutting tool 1 of FIG. 1 and the components around the cutting tip 2.

As shown in FIG. 2, the fixture 31 includes a shaft portion 31a and an enlarged-diameter portion 31b located at one end of the shaft portion 31a. The enlarged-diameter portion 31b is engaged with a peripheral edge of the through hole 2a of the cutting tip 2. As shown in FIG. 3, the shaft portion 31a includes a depressed portion 31c which is located at part of the shaft portion 31a and is depressed inward in a radial direction of the shaft portion 31a. The stopper 32 is a member including a shaft portion. The stopper 32 includes an engagement groove 32a and a first thread 32b. The engagement groove 32a is located at one axial end surface of the stopper 32 and is engaged with a fastening tool. The first thread 32b is located at a peripheral surface of the stopper 32.

The head block 3a includes a first guide passage R1 and a second guide passage R2. The shaft portion 31a of the fixture 31 is inserted into and guided by the first guide passage R1, and the stopper 32 is inserted into and guided by the second guide passage R2. The guide passages R1 and R2 extend in respective directions intersecting with each other and communicate with each other. Moreover, the attachment structure 3c includes a second thread 3f which is located on an inner peripheral surface of the head block 3a and is threadedly engaged with the first thread 32b. This inner peripheral surface of the head block 3a defines the second guide passage R2.

In a state where the seat 30 is located on the tip seat surface 3d, and the cutting tip 2 is located on a surface of the seat 30 which is located at an opposite side of the tip seat surface 3d, the shaft portion 31a is inserted into the through holes 2a and 30a and the first guide passage R1. Moreover, in a state where the fastening tool is engaged with the engagement groove 32a, the first thread 32b is threadedly engaged with the second thread 3f. As the threads 3f and 32b are threadedly engaged with each other, an insertion-side tip portion of the stopper 32 presses a surface inside the depressed portion 31c in a direction in which the second guide passage R2 extends. Thus, the fixture 31 is pushed toward the inside of the first guide passage R1. At this time, the cutting tip 2 is pressed against the tip seat surface 3d through the seat 30 by the enlarged-diameter portion 31b of the fixture 31.

Moreover, the cutting tip 2 is pressed against a wall surface 3g of the head block 3a which is located between the tip seat surface 3d and the first block surface B1. The cutting tip 2 is positioned relative to the head block 3a by the wall surface 3g of the head block 3a and the surface of the seat 30 which is located at the opposite side of the tip seat surface 3d. Thus, the cutting tip 2 is attached to the cutting tip holder 3 by the attachment structure 3c. The configuration of the attachment structure 3c is not limited to this.

The cutting tip holder 3 includes coolant nozzles. The coolant nozzles eject the coolant that cools heat generated at the cutting tip 2. For example, the coolant can be suitably selected from a liquid, a gas, or a mixture of these. The coolant of the present embodiment includes water.

The cutting tip holder 3 includes a first coolant nozzle 33 including at least one discharge port. As shown in FIG. 1, the first coolant nozzle 33 is located on the first block surface B1 of the head block 3a. The at least one discharge port of the first coolant nozzle 33 is located so as to be directed to the first tip surface C1 of the cutting tip 2.

The cutting tip holder 3 includes at least one second coolant nozzle including at least one discharge port. The at least one second coolant nozzle is located on at least one of the second block surface B2 or third block surface B3 of the head block 3a. The at least one discharge port of the second coolant nozzle is located so as to be directed to the second tip surface C2 or third tip surface C3 of the cutting tip 2.

The at least one second coolant nozzle of the present embodiment may include a pair of second coolant nozzles 34 and 35 which are respectively located on the second block surface B2 and third block surface B3 of the head block 3a. In this case, for example, the second coolant nozzle 34 is located on the second block surface B2. Moreover, the second coolant nozzle 35 is located on the third block surface B3.

Between the discharge port of the first coolant nozzle 33 and the discharge ports of the second coolant nozzles 34 and 35 in the cutting tip holder 3 of the present embodiment, at least the discharge ports of the second coolant nozzles 34 and 35 are directed to the machining point C4. In the present embodiment, as one example, all of the discharge port of the first coolant nozzle 33 and the discharge ports of the second coolant nozzles 34 and 35 are directed to the machining point C4 of the cutting tip 2.

The at least one discharge port of the first coolant nozzle 33 includes, for example, discharge ports 33a to 33c. As shown in FIG. 2, when viewed in the normal direction Z of the first tip surface C1, the discharge ports 33a to 33c are located at different positions. Therefore, a rich amount of coolant is ejected from the discharge ports 33a to 33c toward the machining point C4 from directions different from each other. The first coolant nozzle 33 of the present embodiment is located at a position that projects outward from the first block surface B1. Thus, the coolant which has been ejected from the discharge ports 33a to 33c toward the first tip surface C1 easily reaches the machining point C4 of the cutting tip 2.

As one example, the second coolant nozzle 34 includes one discharge port 34a, and the second coolant nozzle 35 includes one discharge port 35a. The coolant is ejected from the discharge ports 34a and 35a of the pair of second coolant nozzles 34 and 35 toward the machining point C4 from directions different from each other. The second coolant nozzle 34 of the present embodiment is located at a position that projects outward from the second block surface B2. Thus, the coolant which has been ejected from the discharge port 34a toward the second tip surface C2 easily reaches the machining point C4 of the cutting tip 2. Moreover, the second coolant nozzle 35 of the present embodiment is located at a position that projects outward from the third block surface B3. Thus, the coolant which has been ejected from the discharge port 35a toward the third tip surface C3 easily reaches the machining point C4 of the cutting tip 2.

As one example, inner diameters of the discharge ports 33a to 33c of the present embodiment are the same as each other. Moreover, as one example, inner diameters of the discharge ports 34a and 35a are the same as each other. Each of the inner diameters of the discharge ports 34a and 35a of the present embodiment is larger than each of the inner diameters of the discharge ports 33a to 33c. Each of the inner diameters of the discharge ports 34a and 35a may be smaller than each of the inner diameters of the discharge ports 33a to 33c or may be the same as each of the inner diameters of the discharge ports 33a to 33c.

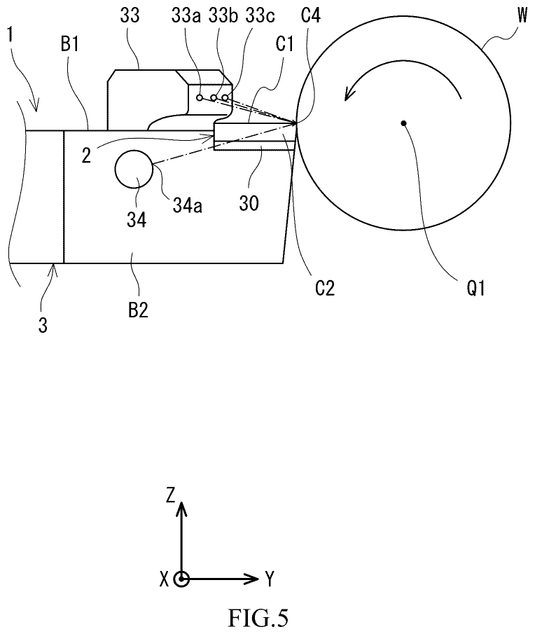

In the cutting tip holder 3 of the present embodiment, as one example, a shortest distance between the machining point C4 and each of the second coolant nozzles 34 and 35 is longer than a shortest distance between the machining point C4 and the first coolant nozzle 33. Thus, the second coolant nozzles 34 and 35 are prevented from interfering with the workpiece W, the chips, and the like in a state where the machining point C4 is in contact with the workpiece W. Therefore, the coolant from the second coolant nozzles 34 and 35 can be stably supplied toward the second tip surface C2 and the third tip surface C3. As one example, when the first tip surface C1 is a horizontal surface, the discharge ports 34a and 35a are located at positions lower than the first tip surface C1 (see FIG. 5).

As shown in FIG. 2, the head block 3a of the present embodiment may have such a shape that when viewed in one direction (herein, the normal direction Z of the first tip surface C1), the first block surface B1 is visually recognized; and the second block surface B2 and the third block surface B3 are not visually recognized.

When viewed in the above direction, the pair of second coolant nozzles 34 and 35 may be entirely located inside a below-described region A in the head block 3a. The pair of second coolant nozzles 34 and 35 are located inside the region A symmetrically with respect to a symmetric axis S between the second block surface B2 and the third block surface B3.

The head block 3a of the present embodiment may have such a shape that when viewed in the above direction, the first block surface B1 is visually recognized, and the second block surface B2 and the third block surface B3 are not visually recognized, and in addition, the pair of second coolant nozzles 34 and 35 may be entirely located inside the region A.

When viewed in the above direction, the region A is a region which is sandwiched by straight lines L1 and L2 and includes the first block surface B1. The straight lines L1 and L2 are a pair of straight lines orthogonal to each other when viewed in the above direction (i.e., an angle between the straight lines L1 and L2 is 90°), and are straight lines which pass through the machining point C4 of the cutting tip 2 as an intersecting point and are located symmetrically with respect to the symmetric axis S between the second block surface B2 and the third block surface B3.

According to the above configuration, the second block surface B2, the third block surface B3, and the second coolant nozzles 34 and 35 can be prevented from interfering with the workpiece W, the chips, and the like. Therefore, the coolant from the second coolant nozzles 34 and 35 can be stably supplied toward the second tip surface C2 and the third tip surface C3.

The arrangement of the pair of second coolant nozzles 34 and 35 is not limited to this. For example, when viewed in the above direction, at least part of each of the pair of second coolant nozzles 34 and 35 may be located outside the region A. Moreover, when viewed in the above direction, the pair of second coolant nozzles 34 and 35 may be located inside the region A asymmetrically with respect to the symmetric axis S.

As one example, when viewed in the above direction, the pair of second coolant nozzles 34 and 35 are entirely located between a plane P1 including the second tip surface C2 and a plane P2 including the third tip surface C3, and the planes P1 and P2 are located inside the region A symmetrically with respect to the symmetric axis S. When viewed in the above direction, the pair of second coolant nozzles 34 and 35 are located between the planes P1 and P2 symmetrically with respect to the symmetric axis S. As one example, an angle between the planes P1 and P2 is a value in a range of less than 90°.

According to the above configuration, since a projection amount of the second coolant nozzle 34 projecting outward from the block surface B2 and a projection amount of the second coolant nozzle 35 projecting outward from the block surface B3 are suppressed, the pair of second coolant nozzles 34 and 35 are prevented from interfering with the workpiece W, the chips, and the like. Therefore, the coolant from the second coolant nozzles 34 and 35 can be stably supplied toward the second tip surface C2 and the third tip surface C3. The arrangement of the pair of second coolant nozzles 34 and 35 is not limited to this. For example, when viewed in the above direction, at least part of each of the pair of second coolant nozzles 34 and 35 may be located outside the region between the planes P1 and P2. Moreover, when viewed in the above direction, the pair of second coolant nozzles 34 and 35 may be located between the planes P1 and P2 asymmetrically with respect to the symmetric axis S. Moreover, the angle between the planes P1 and P2 may be a value in a range of 90° or more.

In the cutting tip holder 3 of the present embodiment, at least one of the first coolant nozzle 33 or the group of the second coolant nozzles 34 and 35 (in the present embodiment, both of the first coolant nozzle 33 and the group of the second coolant nozzles 34 and 35) is detachably attached to the head block 3a. The first coolant nozzle 33 of the present embodiment is attached to the first block surface B1 of the head block 3a by fastening structures. Moreover, the second coolant nozzles 34 and 35 of the present embodiment are respectively attached to the second block surface B2 and the third block surface B3 by fastening structures. Thus, the coolant nozzles 33 to 35 are individually and easily attached to and detached from the head block 3a.

The cutting tip holder 3 of the present embodiment includes a coolant channel R3 through which the coolant flows. For example, the coolant channel R3 includes a first channel R31, a second channel R32, and at least one third channel R33, R34. The coolant supplied from an outside flows through the first channel R31. In a state where the attachment block 3b of the cutting tip holder 3 of the present embodiment is attached to the cutter, the coolant is supplied from the cutter to the first channel R31.

The second channel R32 extends from the first channel R31 toward the first coolant nozzle 33. As one example, the at least one third channel of the present embodiment includes a pair of third channels R33 and R34. The third channel R33 extends from the first channel R31 toward the second coolant nozzle 35. The third channel R34 extends from the first channel R31 toward the second coolant nozzle 34. As one example, the coolant channel R3 of the present embodiment is located inside the head block 3a. Thus, the cutting tip holder 3 can be made compact. The entire coolant channel R3 or part of the coolant channel R3 may be located outside the head block 3a.

As one example, in the head block 3a of the present embodiment, an angle between the first block surface B1 and the second block surface B2 is a value in a range of less than 90°, and an angle between the first block surface B1 and the third block surface B3 is a value in a range of less than 90°. Each of the above angles is, for example, a value in a range of 45° or more and 80° or less.

According to the above configuration, when viewed in the normal direction Z of the first tip surface C1, the projection amount of the second coolant nozzle 34 projecting outward beyond a boundary position between the first block surface B1 and the second block surface B2 can be suppressed. Moreover, when viewed in the normal direction Z of the first tip surface C1, the projection amount of the second coolant nozzle 35 projecting outward beyond a boundary position between the first block surface B1 and the third block surface B3 can be suppressed. Thus, the pair of second coolant nozzles 34 and 35 can be further prevented from interfering with the workpiece W, the chips, and the like. Therefore, the coolant from the pair of second coolant nozzles 34 and 35 can be stably supplied toward the second tip surface C2 and the third tip surface C3.

The arrangement of the block surfaces B1 to B3 is not limited to this. For example, in the head block 3a, the angle between the first block surface B1 and the second block surface B2 or the angle between the first block surface B1 and the third block surface B3 may be a value in a range of 90° or more. In this case, the angle between the first block surface B1 and the second block surface B2 or the angle between the first block surface B1 and the third block surface B3 may be a value in a range of 90° or more and 120° or less.

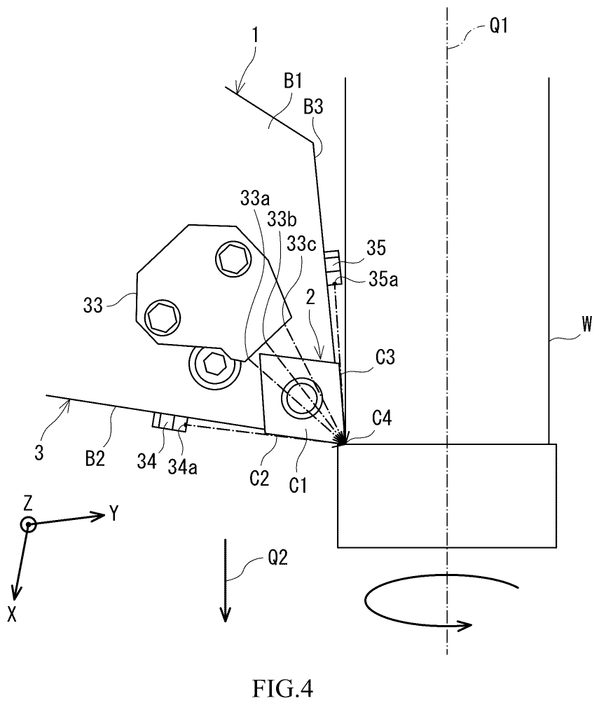

FIG. 4 is a partial view viewed from a side where the first tip surface C1 of the cutting tool 1 of FIG. 1 which is performing the cutting work is located. As one example, FIG. 4 shows that while the workpiece W having a columnar body shape is being rotated, the cutting tool 1 subjects the workpiece W to lathe machining by outer diameter machining. FIG. 5 is a partial view viewed from a side where the second tip surface C2 of the cutting tool 1 of FIG. 1 which is performing the cutting work is located. When using the cutting tool 1, the attachment block 3b of the cutting tool 1 is attached to the cutter.

As shown in FIG. 4, as one example, the workpiece W is rotated about a rotation axis Q1. Moreover, as shown in FIG. 5, as one example, when viewed in an axial direction of the rotation axis Q1, the rotation axis Q1 and the first tip surface C1 of the cutting tip 2 are set so as to be located on the same plane. The block surfaces B1 to B3 of the head block 3a are maintained at positions away from the workpiece W. In this state, the machining point C4 of the cutting tip 2 held by the cutting tip holder 3 is brought into contact with the surface of the workpiece W. As one example, the cutting tool 1 is made to move in a cutting direction Q2 while contacting the workpiece W. The cutting direction Q2 is the axial direction of the rotation axis Q1. Thus, a predetermined region of the workpiece W is cut by the cutting tool 1.

In the cutting tool 1, the coolant is supplied to the coolant channel R3. The coolant is ejected from the discharge ports 33a to 33c, 34a, and 35a of the first coolant nozzle 33 and the second coolant nozzles 34 and 35. The coolant is supplied toward the tip surfaces C1 to C3 of the cutting tip 2 and cools the machining point C4.

According to the cutting tool 1, a rich amount of coolant ejected from the first coolant nozzle 33 and the second coolant nozzles 34 and 35 is supplied toward the tip surfaces C1 to C3 of the cutting tip 2. The first coolant nozzle 33 supplies the coolant toward the first tip surface C1. The second coolant nozzles 34 and 35 supply the coolant toward the second tip surface C2 and the third tip surface C3.

According to the above configuration, even when the cutting tip is hardly cooled only by the coolant ejected from the first coolant nozzle 33 toward the first tip surface C1, the machining point C4 of the cutting tip 2 can be cooled from different directions by the coolant ejected from the second coolant nozzles 34 and 35 toward the second tip surface C2 and the third tip surface C3. Therefore, the cooling effect of the cutting tip 2 can be improved.

Since the cooling effect of the cutting tip 2 is improved, for example, abrasion of base metal of the cutting tip 2 can be suppressed. Moreover, when the cutting tip 2 includes a coating film, the coating film can be prevented from being peeled off.

### Modified Example 1

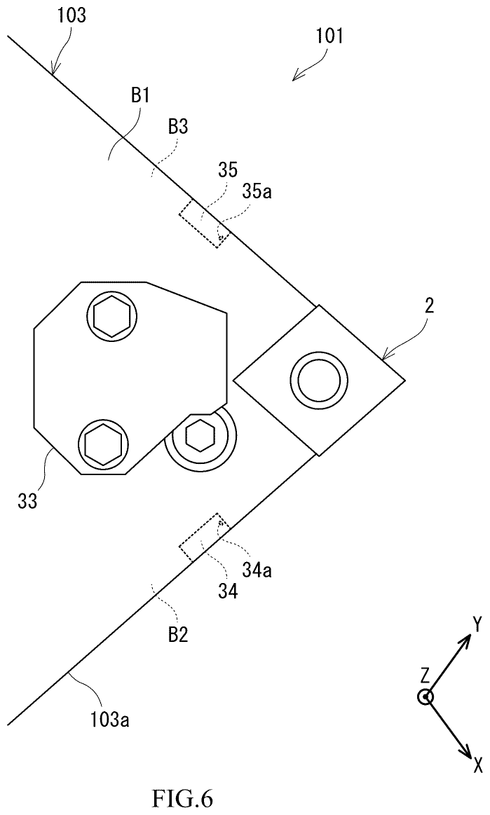

Hereinafter, modified examples of the present embodiment will be described. FIG. 6 is a partial view showing the cutting tip 2 attached to a cutting tool 101 according to Modified Example 1 and components around the cutting tip 2.

As shown in FIG. 6, a head block 103a of a cutting holder 103 according to Modified Example 1 has such a shape that when viewed in one direction (as one example, the normal direction Z of the first tip surface C1), the first block surface B1 is visually recognized, and the second block surface B2 and the third block surface B3 are not visually recognized.

Moreover, when viewed in the above direction, the at least one second coolant nozzle (as one example, the pair of second coolant nozzles 34 and 35) is located at such a position as not to be visually recognized. Thus, when viewed in the above direction, the discharge port of one second coolant nozzle or the discharge ports of the second coolant nozzles (as one example, the discharge ports 34a and 35a) among the at least one second coolant nozzle is/are located at such a position or positions as not to be visually recognized.

According to the above configuration, the projection amount of the second coolant nozzle projecting outward from at least one of the second block surface B2 or the third block surface B3 can be suppressed. As a result, the second coolant nozzle can be prevented from interfering with the workpiece W, the chips, and the like. Therefore, the coolant from the second coolant nozzle can be stably supplied toward at least one of the second tip surface C2 or the third tip surface C3.

### Modified Example 2

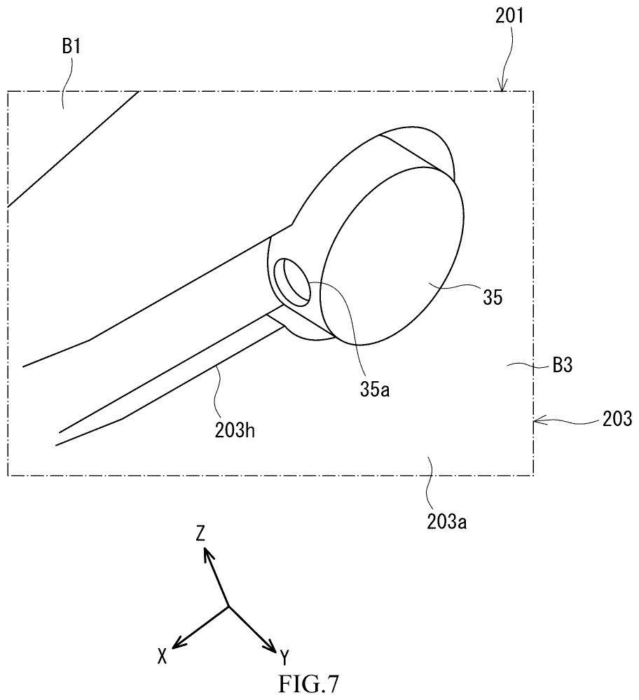

FIG. 7 is a partial view showing a cutting tool 201 according to Modified Example 2. FIG. 7 shows an enlarged view of part of the third block surface B3 of the cutting tool 201 (cutting tip holder 203). A head block 203a of the cutting tip holder 203 according to Modified Example 2 includes a coolant groove 203 h located on a block surface that is at least one of the second block surface B2 or the third block surface B3.

As shown in FIG. 7, the coolant groove 203h extends toward the cutting tip 2 from the second coolant nozzle (the second coolant nozzle 35 in the example shown in FIG. 7) located on the block surface. Moreover, at least part of the discharge port (the discharge port 35a in the example shown in FIG. 7) of the second coolant nozzle is located inside the coolant groove 203h.

According to the above configuration, for example, since the coolant is ejected from the discharge port of the second coolant nozzle to the inside of the coolant groove 203h, the coolant which has flowed through the coolant groove 203h can be accurately brought into contact with the second tip surface C2 or third tip surface C3 of the cutting tip 2. As a result, the cooling effect of the cutting tip 2 can be further improved.

The foregoing has described the embodiment and the modified examples as examples of the technology disclosed in the present application. However, the technology in the present disclosure is not limited to these and is applicable to embodiments in which modifications, replacements, additions, omissions, and the like have been suitably made. Moreover, a new embodiment may be prepared by combining the components described in the above embodiment and the above modified examples. For example, some of components in one embodiment may be applied to another configuration. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

### DISCLOSED ASPECTS

The following aspects disclose preferred embodiments.

### First Aspect

A cutting tip holder that holds a cutting tip, the cutting tip including a first tip surface, a second tip surface, and a third tip surface, each of the first tip surface, the second tip surface, and the third tip surface being located adjacent to the other two tip surfaces,
the cutting tip holder including:
a head block to which the cutting tip is attached;
a first coolant nozzle including at least one discharge port; and
at least one second coolant nozzle including at least one discharge port, wherein:
the head block includes
   a first block surface, a second block surface, and a third block surface, each of the first block surface, the second block surface, and the third block surface being located adjacent to the other two block surfaces, and
   an attachment structure by which the cutting tip is attached in such a posture that the first block surface is visually recognized when viewed in a normal direction of the first tip surface, the second block surface is visually recognized when viewed in a normal direction of the second tip surface, and the third block surface is visually recognized when viewed in a normal direction of the third tip surface;
the first coolant nozzle is located on the first block surface of the head block;
the second coolant nozzle is located on at least one of the second block surface or third block surface of the head block;
the at least one discharge port of the first coolant nozzle is located so as to be directed to the first tip surface of the cutting tip; and
the at least one discharge port of the second coolant nozzle is located so as to be directed to the second tip surface or third tip surface of the cutting tip.

According to the above configuration, the cutting tip held by the cutting tip holder can be cooled by a rich amount of coolant ejected from the first coolant nozzle and the second coolant nozzle. Moreover, even when the cutting tip is hardly cooled only by the coolant ejected from the first coolant nozzle toward the first tip surface, the cutting tip can be cooled by the coolant ejected from the second coolant nozzle toward the second tip surface or the third tip surface. Therefore, the cooling effect of the cutting tip can be improved.

### Second Aspect

The cutting tip holder according to the first aspect, wherein:
the at least one second coolant nozzle includes a pair of second coolant nozzles that are respectively located on the second block surface and third block surface of the head block;
the at least one discharge port of one of the pair of second coolant nozzles is located so as to be directed to the second tip surface of the cutting tip; and
the at least one discharge port of the other of the pair of second coolant nozzles is located so as to be directed to the third tip surface of the cutting tip.

According to the above configuration, the coolant is supplied to both of the second tip surface and the third tip surface by using the pair of second coolant nozzles, and thus, the cutting tip can be cooled. Therefore, the cooling effect of the cutting tip can be further improved.

### Third Aspect

The cutting tip holder according to the first or second aspect, wherein between the discharge port of the first coolant nozzle and the discharge port of the second coolant nozzle, at least the discharge port of the second coolant nozzle is directed to a machining point located at a boundary among the first tip surface, second tip surface, and third tip surface of the cutting tip.

According to the above configuration, the machining point that is a portion of the cutting tip which contacts the workpiece can be efficiently cooled by the coolant ejected from at least the second coolant nozzle.

### Fourth Aspect

The cutting tip holder according to any one of the first to third aspects, wherein a shortest distance between the second coolant nozzle and a machining point located at a boundary among the first tip surface, second tip surface, and third tip surface of the cutting tip is longer than a shortest distance between the first coolant nozzle and the machining point.

According to the above configuration, since the second coolant nozzle is located farther away from the machining point of the cutting tip than the first coolant nozzle, the second coolant nozzle can be prevented from interfering with the workpiece, the chips, and the like.

Therefore, the coolant from the second coolant nozzle can be stably supplied toward at least one of the second tip surface or the third tip surface.

### Fifth Aspect

The cutting tip holder according to any one of the first to fourth aspects, wherein when viewed in the normal direction of the first tip surface, the at least one discharge port of the first coolant nozzle includes discharge ports located at different positions.

According to the above configuration, since a rich amount of coolant is ejected from the discharge ports of the first coolant nozzle in different directions, the cooling effect of the cutting tip can be improved. Moreover, the projection amount of the first coolant nozzle projecting from the first block surface can be suppressed. Therefore, the cutting tip holder can be made compact.

### Sixth Aspect

The cutting tip holder according to any one of the first to fifth aspects, wherein the head block has such a shape that when viewed in one direction, the first block surface is visually recognized, and the second block surface and the third block surface are not visually recognized.

According to the above configuration, since the projection amount of the second block surface projecting outward and the projection amount of the third block surface projecting outward can be suppressed, the head block can be prevented from interfering with the workpiece, the chips, and the like. Therefore, the coolant from the second coolant nozzle can be stably supplied toward at least one of the second tip surface or the third tip surface.

### Seventh Aspect

The cutting tip holder according to any one of the first to sixth aspects, wherein:
the at least one second coolant nozzle includes a pair of second coolant nozzles that are respectively located on the second block surface and third block surface of the head block; and
when viewed in one direction, the pair of second coolant nozzles are entirely located inside a region which includes the first block surface and is sandwiched by a pair of straight lines which are orthogonal to each other, extend through a machining point as an intersecting point, and are located symmetrically with respect to a symmetric axis between the second block surface and the third block surface, the machining point being located at a boundary among the first tip surface, second tip surface, and third tip surface of the cutting tip.

According to the above configuration, since the projection amounts of the pair of second coolant nozzles projecting outward from the second block surface and the third block surface can be suppressed, the pair of second coolant nozzles can be prevented from interfering with the workpiece, the chips, and the like. Therefore, the coolant from the pair of second coolant nozzles can be stably supplied toward both of the second tip surface and the third tip surface.

### Eighth Aspect

The cutting tip holder according to the seventh aspect, wherein when viewed in the one direction, the pair of second coolant nozzles are entirely located between a plane including the second tip surface and a plane including the third tip surface, the planes being located inside the region symmetrically with respect to the symmetric axis between the the second tip surface and third tip surface of the cutting tip.

According to the above configuration, since the projection amounts of the pair of second coolant nozzles projecting outward from the second block surface and the third block surface can be further suppressed, the pair of second coolant nozzles can be further prevented from interfering with the workpiece, the chips, and the like. Therefore, the coolant from the pair of second coolant nozzles can be stably supplied toward both of the second tip surface and the third tip surface.

### Ninth Aspect

The cutting tip holder according to any one of the first to eighth aspects, wherein:
an angle between the first block surface and the second block surface is a value in a range of less than 90°; and
an angle between the first block surface and the third block surface is a value in a range of less than 90°.

According to the above configuration, since the projection amounts of the second coolant nozzles projecting outward from the second block surface and the third block surface when viewed in the normal direction of the first tip surface of the cutting tip can be reduced, the second coolant nozzles can be satisfactorily prevented from interfering with the workpiece, the chips, and the like. Therefore, the coolant from the pair of second coolant nozzles can be stably supplied toward at least one of the second tip surface or the third tip surface.

### Tenth Aspect

The cutting tip holder according to any one of the first to ninth aspects, wherein:
the head block has such a shape that when viewed in one direction, the first block surface is visually recognized, and the second block surface and the third block surface are not visually recognized; and
when viewed in the one direction, the at least one second coolant nozzle is located at such a position as not to be visually recognized.

According to the above configuration, since the projection amount of the second coolant nozzle projecting outward from a block surface that is at least one of the second block surface or the third block surface can be suppressed, the second coolant nozzle can be prevented from interfering with the workpiece, the chips, and the like. Therefore, the coolant from the second coolant nozzle can be stably supplied toward at least one of the second tip surface or the third tip surface.

### Eleventh Aspect

The cutting tip holder according to any one of the first to tenth aspects, including a coolant channel through which coolant flows, wherein
the coolant channel includes
   a first channel through which the coolant supplied from an outside flows,
   a second channel extending from the first channel toward the first coolant nozzle, and
   at least one third channel extending from the first channel toward the second coolant nozzle.

According to the above configuration, the channels that supply the coolant to the first coolant nozzle and the second coolant nozzle can be unified. Therefore, the coolant channel can be made compact and simple.

### Twelfth Aspect The cutting tip holder according to the eleventh aspect, wherein the coolant channel is located inside the head block.

According to the above configuration, the cutting tip holder can be made more compact than when the coolant channel is located outside the head block. Moreover, since the coolant channel can be protected from an outside, the coolant can be stably supplied to the surface of the cutting tip.

### Thirteenth Aspect

The cutting tip holder according to any one of the first to twelfth aspects, wherein at least one of the first coolant nozzle or the second coolant nozzle is detachably attached to the head block.

According to the above configuration, at least one of the first coolant nozzle or the second coolant nozzle can be easily detached from the head block and replaced in accordance with the cutting tip. Therefore, the cooling effect by the coolant can be stably obtained in accordance with the cutting tip.

### Fourteenth Aspect

The cutting tip holder according to any one of the first to thirteenth aspects, wherein:
the head block includes a coolant groove which is located on a block surface that is at least one of the second block surface or the third block surface, and extends toward the cutting tip from the second coolant nozzle located on the block surface; and
at least part of the discharge port of the second coolant nozzle is located inside the coolant groove.

According to the above configuration, since the coolant is ejected to the inside of the coolant groove, the coolant which has flowed through the coolant groove can be supplied toward the second tip surface or third tip surface of the cutting tip while preventing the coolant from interfering with the block surface. Therefore, the cooling effect of the cutting tip can be further improved.

### Fifteenth Aspect

A cutting tool including:
the cutting tip holder according to any one of the first to fourteenth aspects; and
the cutting tip.

The above configuration can realize the cutting tool that can stably perform the cutting work while maintaining a state of the cutting tip, which is suitable for the cutting, by improving the cooling effect of the cutting tip.

### REFERENCE SIGNS LIST

B1 first block surface
B2 second block surface
B3 third block surface
C1 first tip surface
C2 second tip surface
C3 third tip surface
C4 machining point
R3 coolant channel
R31 first coolant channel
R32 second coolant channel
R33, R34 third coolant channel
S symmetric axis
1,101,201 cutting tool
2 cutting tip
3, 103,203 cutting tip holder
3a, 103a, 203a head block
3c attachment structure
33 first coolant nozzle
33a, 33b, 33c, 34a, 35a discharge port
34, 35 second coolant nozzle
203h coolant groove

1. A cutting tip holder that holds a cutting tip, the cutting tip including a first tip surface, a second tip surface, and a third tip surface, each of the first tip surface, the second tip surface, and the third tip surface being located adjacent to the other two tip surfaces, the cutting tip holder comprising:
a head block to which the cutting tip is attached;
a first coolant nozzle including a discharge port; and
a second coolant nozzle including a discharge port, wherein:
the head block includes a first block surface, a second block surface, and a third block surface, each of the first block surface, the second block surface, and the third block surface being located adjacent to the other two block surfaces;
the cutting tip is attached to the head block in such a posture that the first block surface is visually recognized when viewed in a normal direction of the first tip surface, the second block surface is visually recognized when viewed in a normal direction of the second tip surface, and the third block surface is visually recognized when viewed in a normal direction of the third tip surface;
the discharge port of the first coolant nozzle is located so as to be directed to the first tip surface of the cutting tip; and
the discharge port of the second coolant nozzle is located so as to be directed to the second tip surface or third tip surface of the cutting tip.

2. The cutting tip holder according to claim 1, wherein:
the second coolant nozzle comprises a pair of second coolant nozzles, one of which is located so as to overlap the second block surface when viewed in a normal direction of the second block surface, the other of which is located so as to overlap the third block surface when viewed in a normal direction of the third block surface;
the discharge port of one of the pair of second coolant nozzles is directed to the second tip surface of the cutting tip; and
the discharge port of the other of the pair of second coolant nozzles is directed to the third tip surface of the cutting tip.

3. The cutting tip holder according to claim 1, wherein the discharge port of the second coolant nozzle is directed to a machining point located at a boundary among the first tip surface, second tip surface, and third tip surface of the cutting tip.

4. The cutting tip holder according to claim 1, wherein a shortest distance between the second coolant nozzle and a machining point located at a boundary among the first tip surface, second tip surface, and third tip surface of the cutting tip is longer than a shortest distance between the first coolant nozzle and the machining point.

5. The cutting tip holder according to claim 1, wherein when viewed in the normal direction of the first tip surface, the discharge port of the first coolant nozzle comprises discharge ports located at different positions.

6. The cutting tip holder according to claim 1, wherein the head block has such a shape that when viewed in one direction, the first block surface is visually recognized, and the second block surface and the third block surface are not visually recognized.

7. The cutting tip holder according to claim 1, wherein:
the second coolant nozzle comprises a pair of second coolant nozzles, one of which is located so as to overlap the second block surface when viewed in a normal direction of the second block surface, the other of which is located so as to overlap the third block surface when viewed in a normal direction of the third block surface; and
when viewed in one direction, the pair of second coolant nozzles are entirely located inside a region which includes the first block surface and is sandwiched by a pair of straight lines which are orthogonal to each other, extend through a machining point as an intersecting point, and are located symmetrically with respect to a symmetric axis between the second block surface and the third block surface, the machining point being located at a boundary among the first tip surface, second tip surface, and third tip surface of the cutting tip.

8. The cutting tip holder according to claim 7, wherein when viewed in the one direction, the pair of second coolant nozzles are entirely located between a plane including the second tip surface and a plane including the third tip surface, the planes being located inside the region symmetrically with respect to the symmetric axis between the the second tip surface and third tip surface of the cutting tip.

9. The cutting tip holder according to claim 1, wherein:
an angle between the first block surface and the second block surface is a value in a range of less than 90°; and
an angle between the first block surface and the third block surface is a value in a range of less than 90°.

10. The cutting tip holder according to claim 1, wherein
when viewed in one direction, the second coolant nozzle is located at such a position as not to be visually recognized.

11. The cutting tip holder according to claim 1, comprising a coolant channel through which coolant flows, wherein
the coolant channel includes
a first channel through which the coolant supplied from an outside flows,
a second channel extending from the first channel toward the first coolant nozzle, and
a third channel extending from the first channel toward the second coolant nozzle.

12. The cutting tip holder according to claim 11, wherein the coolant channel is located inside the head block.

13. The cutting tip holder according to claim 1, wherein at least one of the first coolant nozzle or the second coolant nozzle is detachably attached to the head block.

14. The cutting tip holder according to claim 1, wherein:
the head block includes a coolant groove which is located on a block surface that is at least one of the second block surface or the third block surface, and extends toward the cutting tip from the second coolant nozzle located on the block surface; and
at least part of the discharge port of the second coolant nozzle is located inside the coolant groove.

15. A cutting tool comprising:
a cutting tip including a first tip surface, a second tip surface, and a third tip surface, each of the first tip surface, the second tip surface, and the third tip surface being located adjacent to the other two tip surfaces; and
a cutting tip holder that holds the cutting tip and includes
a head block to which the cutting tip is attached,
a first coolant nozzle including a discharge port, and
a second coolant nozzle including a discharge port, wherein:
the head block includes a first block surface, a second block surface, and a third block surface, each of the first block surface, the second block surface, and the third block surface being located adjacent to the other two block surfaces;
the cutting tip is attached to the head block in such a posture that the first block surface is visually recognized when viewed in a normal direction of the first tip surface, the second block surface is visually recognized when viewed in a normal direction of the second tip surface, and the third block surface is visually recognized when viewed in a normal direction of the third tip surface;
the discharge port of the first coolant nozzle is located so as to be directed to the first tip surface of the cutting tip; and
the discharge port of the second coolant nozzle is located so as to be directed to the second tip surface or third tip surface of the cutting tip.

16. The cutting tool according to claim 15, wherein:
when viewed in a normal direction of the first block surface, the first coolant nozzle is located so as to overlap the first block surface of the head block; and
when viewed in a normal direction of a specific block surface that is at least one of the second block surface or third block surface of the head block, the second coolant nozzle is located so as to overlap the specific block surface.

17. The cutting tip holder according to claim 1, wherein:
when viewed in a normal direction of the first block surface, the first coolant nozzle is located so as to overlap the first block surface of the head block; and
when viewed in a normal direction of a specific block surface that is at least one of the second block surface or third block surface of the head block, the second coolant nozzle is located so as to overlap the specific block surface.

18. The cutting tip holder according to claim 1, wherein:
when viewed in a normal direction of a specific block surface that is at least one of the second block surface or third block surface of the head block, the second coolant nozzle is located so as to overlap the specific block surface;
a direction that extends along the normal direction of the first tip surface from the first tip surface toward a surface of the cutting tip which is opposite to the first tip surface is defined as a lower direction; and
the discharge port of the second coolant nozzle is located lower than a machining point located at a boundary among the first tip surface, the second tip surface, and the third tip surface, is located so as to be directed to the machining point of the cutting tip, and is located so as to be separated from the machining point in a direction along the specific block surface when viewed in the normal direction of the first tip surface.

19. The cutting tip holder according to claim 18, wherein:
the head block includes a tip seat surface opposed to the surface of the cutting tip which is opposite to the first tip surface; and
when viewed in one direction, the pair of second coolant nozzles are entirely located inside a region so as to be separated from the tip seat surface and the machining point, the region including the first block surface and being sandwiched by a pair of straight lines which are orthogonal to each other, extend through the machining point as an intersecting point, and are located symmetrically with respect to a symmetric axis between the second block surface and the third block surface.
